(19) United States
(12) Patent Application Publication
(10) Pub. No.: US 2026/0185942 A1
(43) Pub. Date: Jul. 2, 2026

(54) DEVICES, SYSTEMS, AND METHODS FOR THE CONCENTRATION AND/OR DETECTION OF ANALYTES

(71) Applicant: BOARD OF REGENTS, THE UNIVERSITY OF TEXAS SYSTEM, Austin, TX (US)

(72) Inventors: Donglei FAN, Austin, TX (US); Jianhe GUO, Austin, TX (US)

(21) Appl. No.: 19/126,594

(22) PCT Filed: Nov. 2, 2023
(86) PCT No.: PCT/US2023/078553

§ 371 Date: May 1, 2025

Related U.S. Application Data
(60) Provisional application No. 63/421,934, filed on Nov. 2, 2022.

(51) Int. Cl. G01N 21/65; G01N 1/40

(52) U.S. Cl. CPC G01N 21/658; G01N 1/40; G01N 2001/4038

(57) ABSTRACT

The present disclosure provides for a system and method for concentrating an analyte for detection. The devices and systems described herein can include a plurality of nanostructures formed from a first semiconductor and protruding from a first surface of a substrate into a chamber. The devices and systems described herein can comprise a working electrode.

### CROSS-REFERENCE TO RELATED APPLICATIONS

This application claims priority to U.S. Provisional Patent Application No. 63/421,934, filed Nov. 2, 2022, which is incorporated herein by reference in its entirety.

### STATEMENT OF GOVERNMENT SUPPORT

This invention was made with government support under Grant Nos. ECCS1710922 and 1150767, awarded by the National Science Foundation. The government has certain rights in the invention.

### BACKGROUND

Efforts have advanced sensors with high sensitivity, but it remains challenging to detect the biochemical molecules that are in ultralow concentrations in solution. In turn, this issue has hindered the practical application of biosensing.

The devices, systems, and methods described herein address these and other needs.

### SUMMARY

In accordance with the purposes of the disclosed materials and methods, as embodied and broadly described herein, the disclosed subject matter, in one aspect, relates to a preconcentration method for Raman detection that can substantially concentrate biochemical molecules in the solution to the detection zone. The local concentration of targeted analytes at the detection zone can be enhanced, improving the detection limit notably. The devices, systems, and methods disclosed herein can enrich the targeted analytes at the detection location for detection. The mechanism by which enrichment occurs can comprise, at least in part, light induced electrokinetic preconcentration. The device can also be applied for other optical sensing methods.

The devices and systems described herein can include a plurality of nanostructures (e.g., a nanorod/nanopillar array) formed from a first semiconductor (e.g., silicon) and protruding from a first surface of a substrate into a chamber. A transparent cover (e.g., an indium-tin-oxide (ITO) glass or fluoride tin oxide (FTO) glass cover) can be positioned over the nanostructures. The nanostructures can be fabricated by any suitable method, such as catalytic hydrofluoride etching. The metallic catalyst, which can include, for example, silver (Ag), gold (Au), or aluminum (Al), can be patterned on the silicon wafer with monodispersed nanoholes by colloidal lithography. Silicon underneath the catalytic film can be etched while the areas of nanoholes by colloidal lithography. As a result, the large arrays of nanostructures with controlled dimensions (e.g., diameters and lengths) can be formed on the substrate. After etching, an insulating polymer layer can be coated on the metallic catalytic film at the bottom of the nanorod array. Further, plasmonic nanoparticles (e.g., silver nanoparticles, gold nanoparticles, or aluminum particles) can be synthesized on the silicon nanorod array for surface-enhanced Raman spectroscopy (SERS) detection and serve as a recognition element, alone or in combination with another component, for the analyte of interest. These processes can be scaled up for mass production at a low cost.

The preconcentration of biochemical molecules can be induced by the opto-electrokinetic effect. A current (e.g., a direct current or an alternating current) electric potential can be applied between the ITO glass and metallic catalytic film. When a laser for SERS detection is shone on the semiconductor nanostructures, photon excitation can generate additional free charge carriers in the nanostructures and increases their electrical conductivity. The change of electric properties of nanostructures can result in the electrokinetic movement of charged biochemical molecules to the excited silicon nanostructures. This process can significantly enrich targeted analytes within a target area (e.g., where the laser impinges) for SERS detection. This mechanism can resolve issues with obtaining data from ultra-sensitive biochemical molecules at ultralow concentrations.

The preconcentration methods described herein can improve the detection limit of assays. Further, the targeted analytes can be concentrated on a photoconductive nanorod array substrate, wherein an excitation laser locally increases the conductivity and induced electrokinetic preconcentration. This preconcentration method can be applicable to a variety of sensing systems, including optical sensors or fluorescent sensing, as well as electrochemical systems.

The devices and systems described herein can comprise a photoconductive working electrode and a conductive counter electrode. Therein, the molecules are enriched in the target region. Therefore, the enriching effect of the light induced electrokinetic preconcentration concentrates the biomolecules for detection. The devices, systems, and methods described herein achieved much higher sensitivity in detecting biomolecules in comparison to conventional methods.

A number of embodiments of the disclosure have been described. Nevertheless, it will be understood that various modifications may be made without departing from the spirit and scope of the invention. Accordingly, other embodiments are within the scope of the following claims.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### BRIEF DESCRIPTION OF DRAWINGS

FIG. 1 depicts an exemplary system in accordance with the present disclosure.

FIG. 2 depicts a top view of an exemplary chamber in accordance with the present disclosure.

FIG. 3 depicts a top view of an exemplary device with multiple chambers in accordance with the present disclosure.

FIG. 4 depicts a diagram and an SEM image of a Y-shaped microfluidic channel with one branch embedded with nanopillars for filtration.

FIG. 5 depicts an exemplary method of fabricating a device of the present disclosure.

FIG. 6 depicts SEM images that show the exemplary device synthesized by the method shown in FIG. 5 at various steps.

FIGS. 7A-7C show scanning electron microscopy (SEM) images illustrating the deposition of uniform 500 nm polystyrene spheres onto the surface of intrinsic silicon. The uniformity of the polystyrene spheres was assessed using the OpenCV program. FIG. 7D shows fabricated samples of metal-assisted etched silicon with a length of 5 μm, designed as the foundational structure for Surface-Enhanced Raman Scattering (SERS) detection substrates. FIG. 7E shows SERS active silver particles that were nucleated and grown along the array of silicon nanowires.

FIGS. 8A-8F depict a characterization of metal assisted etched silicon nanorods. 20 nm Au+10 nm Ag+3 nm Ti metal layers were deposited on silicon surface as the assisted metal.

FIGS. 9A-9D depict an experimental setup for testing an exemplary device.

FIG. 10A shows that upon applying a voltage to the 5 μm silver-coated silicon nanorod samples, a distinct enhancement of the peak at 722 cm⁻¹ was observed for a 1×10⁻⁶M Adenine solution in PBS (0.1×), exhibiting an enhancement ratio of 5.1. FIG. 10B shows the time-dependent data obtained during testing reveals a rapid initial increase in the signal, followed by a slower decrease. FIG. 10C shows that when testing a 1×10⁻⁷M adenine solution in PBS (0.1×) on the same sample as described in FIG. 10A, a discernible enhancement of the adenine peak at 722 cm⁻¹ was observed, resulting in an enhancement ratio of approximately 6.4. FIG. 10D and FIG. 10F show the response to voltage exhibited selectivity towards the 722 cm⁻¹ peak of 1×10⁻⁶M adenine; negative voltages enhanced the peak intensity, while positive voltages suppressed the signal level. FIG. 10E and FIG. 10G shows the observed signal enhancement demonstrated a clear voltage dependency, indicating a proportional increase in the enhancement ratio with higher applied voltages.

FIGS. 11A-11C show testing the behavior of 1×10⁻⁶M Rhodamine 6G (R6G) molecules in D.I. water between in-plane electrode. The experimental setup is illustrated in FIG. 11D. Due to the positive charge of R6G molecules at this solution, the plot indicates their attraction towards the negative bias and repulsion from the positive bias. The motion of the substrate was precisely controlled using the MS2000-ASI Automated Stage. The tests were conducted along a 100 μm wide microchannel, progressing from side B to side A. FIGS. 11E-11F show similar observations were made when testing 1×10⁻⁶M R6G molecules in the vertical direction between two ITO electrodes.

FIG. 12A shows scanning electron microscopy (SEM) images illustrating the synthesis of porous gold through annealing a 20 nm Au+10 Ag film deposited onto a glass substrate at 360 degrees Celsius. FIG. 12B shows the sample from FIG. 12A subsequently coated with an 8 nm SiO₂ layer to inhibit the migration of gold hotspots, ensuring a stable Surface-Enhanced Raman Scattering (SERS) signal. In contrast to the untreated gold film, the SiO₂-coated porous gold exhibits a robust SERS signal. For this specific investigation, a 1×10⁻⁶M Adenine solution in PBS (0.1×) buffer was employed. Notably, Adenine molecules possess near-neutral charge characteristics in the pH ˜7.4 buffer solution. Despite this, a discernible response is observed at the 722 cm⁻¹ peak, as evidenced by FIG. 12E and FIG. 12D. FIG. 12D shows a signal of Adenine 722 cm⁻¹ peak change at 0 mv. FIG. 12E shows a test sequence involving the application of voltages was conducted: +400 mV for 2 minutes, followed by another +400 mV for 2 minutes, and concluding with a −400 mV bias for 4 minutes. It is worth noting that the temporal width between each increase and decrease trend is approximately 175 seconds.

FIGS. 13A-13F depict that the SiNW substrate shows light response. FIGS. 13A-13B depict a sequence of tests. Initially, the light intensity was reduced from 50% to darkness, and the results are presented in FIG. 13A. Subsequently, the light was gradually increased from darkness back to 50%, and the outcomes are shown in FIG. 13B. All of the results consistently demonstrate a particular trend: as the light intensity is increased, there is a corresponding increase in current. Conversely, when the light intensity is reduced, the current in the current-voltage (CV) curve decreases. As a comparison, FIGS. 13D-13E show the results for gold film coated glass sample. When comparing the responses in the same scale, it becomes evident that the gold-coated glass exhibits a reduced sensitivity to light. Nevertheless, it is noteworthy that light still induces slight changes in the graphs. This observed trend is consistently confirmed during the −2V to 2V test. A significant disparity is observed in the area covered by the CV scanning curves. This distinction may be attributed to the silicon nanowires (SiNW), which provide additional surface area for the accumulation of charges. This, in turn, significantly enhances the overall capability of the system. This same effect is also observed during voltage scanning, specifically in the −2V to 2V range. In this scanning process, both reduction and oxidation peaks are augmented as the intensity of the incident light is increased.

FIG. 14 depicts more data provided to support the light response, including fresh SiNW array samples, 1×10⁻³M adenine PBS 0.1× Solution.

FIG. 15 depicts that the detection limit improved by 1000 time with E-field.

FIG. 16A depicts a device diagram shows electric voltages applied between ITO and Au electrodes. At the point of light, biomolecules aggregate. FIG. 16B COMSOL numerical simulation of Light-pinpointed molecule aggregation that shows an ultra-strong enrichment of DNA nucleotides, adenine molecules, occurs just at the point of laser illumination. The initial adenine concentration is 1×10⁻⁶ M.

The components in the drawings are not necessarily to scale relative to each other. Like reference, numerals designate corresponding parts throughout the several views.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, one or more such compounds, compositions, or disorders, and the like.

### Devices, Systems, and Methods

Described herein are devices and systems comprising a chamber having a target region therein, wherein the target region comprises: a substrate formed from a semiconductor and having a first surface; and a plurality of nanostructures formed from a semiconductor and protruding from the first surface of the substrate into the chamber.

The semiconductor(s) can comprise any suitable semiconductor material. Non-limiting examples of semiconductors include group IV semiconductors, such as silicon or germanium; group III-V semiconductors, such as gallium arsenide or indium phosphide; and group II-VI semiconductors, such as cadmium telluride.

In some examples, the devices and systems disclosed herein can comprise a target region with a plurality of silicon nanostructures protruding from a silicon substrate. Using an electric field applied to the target region and irradiation via a laser, the concentration of an analyte in a sample is increased in the target region. Due to the opto-electrokinetic effect created by the laser and applied electric field, a high concentration of the analyte of interest is present in the target region. This can allow for detection of an analyte even when it is present within a sample at an ultralow concentration.

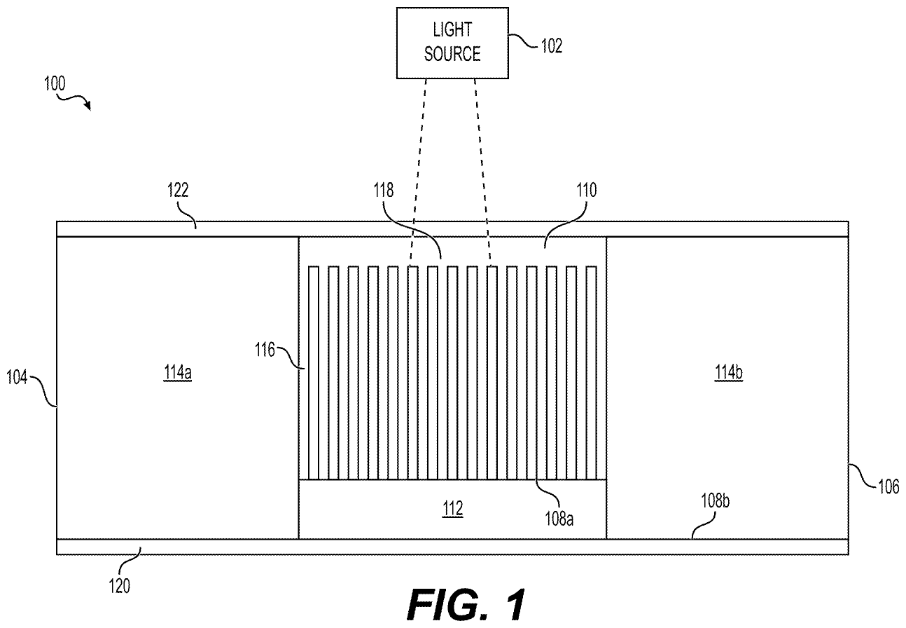

FIG. 1 shows an exemplary system 100. The example system 100 can comprise a light source 102 operably coupled to a device 104. In some embodiments, the light source 102 can be a laser, a lamp, a flashlight, or another suitable light source that can emit electromagnetic radiation. In some embodiments, the light source 102 can be configured to emit white light. In some embodiments, the light source 102 can be configured to emit colored light. In some embodiments, the light source 102 can be configured to emit infrared light or ultraviolet light. For example, the light source can be operatively positioned such that the light source can irradiate the target region.

The device 104 includes a substrate 106. The dimensions of the substrate 106 (e.g., length, width, and thickness) are not particularly limited, and can be selected in view of a number of criteria, including the intended application for the system and the size of the other system components. In some embodiments, the substrate 106 is in the form of a plate or chip. In other embodiments, the substrate 106 may be a surface of an article, such as a probe, research instrument, vial, or microwell plate. In some embodiments, the substrate can comprise a component of a microfluidic device. In some embodiments, the substrates can comprise a semiconductor, such as silicon.

The substrate 106 can have a first surface 108a and a second surface 108b. In some embodiments, the substrate can define a chamber 110. In some embodiments, the chamber 110 can be a microfluidic channel. The chamber 110 can be defined by a floor 112 and two sidewalls 114a, 114b.

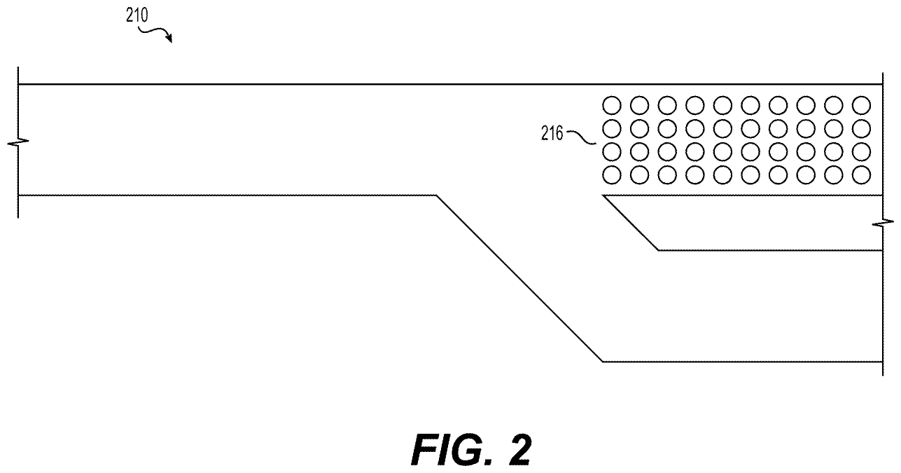

The chamber 110 can include a plurality of nanostructures 116 which protrude from the first surface 108a into the chamber 110. The plurality of nanostructures 116 can be formed from a semiconductor which, in some embodiments, includes silicon. In some embodiments, the plurality of nanostructures 116 are nanopillars. FIG. 2 shows a top view of an example chamber 210 that has a plurality of nanopillars 216.

In some embodiments, the device further includes a plurality of recognition elements disposed on the nanostructures 116. The recognition elements can be any suitable component which facilitates identification (e.g., spectroscopic identification) of an analyte of interest. In some embodiments, the recognition elements can comprise a molecule (e.g., antibody, antibody fragment, antibody mimetic, peptide, oligonucleotide, DNA, RNA, aptamer, organic molecule, or any combination thereof) that selectively associates and/or selectively binds an analyte of interest. In some embodiments, the recognition elements can comprise a material (e.g., Surface Enhanced Raman Spectroscopy (SERS)-active nanostructured metal) which serves as a spectroscopic handle for the detection and/or quantification of an analyte of interest present in the target region.

Recognition elements for particular analytes are known in the art, and can be selected in view of a number of considerations including analyte identity, analyte concentration, and the nature of the sample in which the analyte is to be detected. Suitable recognition element include antibodies, antibody fragments, antibody mimetics (e.g., engineered affinity ligands such as AFFIBODY® affinity ligands), peptides (natural or modified peptides), proteins (e.g., recombinant proteins, host proteins), oligonucleotides, DNA, RNA (e.g., microRNAs), aptamers (nucleic acid or peptide), and organic small molecules (e.g., haptens or enzymatic co-factors).

In some embodiments, the recognition element selectively associates with the analyte. The term “selectively associates”, as used herein when referring to a recognition element, refers to a binding reaction which is determinative for the analyte in a heterogeneous population of other similar compounds. Generally, the interaction is dependent upon the presence of a particular structure (e.g., an antigenic determinant or epitope) on the binding partner. By way of example, an antibody or antibody fragment selectively associates to its particular target (e.g., an antibody specifically binds to an antigen) but it does not bind in a significant amount to other proteins present in the sample or to other proteins to which the antibody may come in contact in an organism.

In some embodiments, a recognition element that “specifically binds” an analyte has an affinity constant (Kₐ) greater than about 10⁵ M⁻¹ (e.g., greater than about 10⁶ M⁻¹, greater than about 10⁷ M⁻¹, greater than about 10⁸ M⁻¹, greater than about 10⁹ M⁻¹, greater than about 10¹⁰ M⁻¹, greater than about 10¹¹ M⁻¹, greater than about 10¹² M⁻¹, or more) with that analyte.

In certain embodiments, the recognition element comprises an antibody. The term “antibody” refers to natural or synthetic antibodies that selectively bind a target antigen. The term includes polyclonal and monoclonal antibodies. In addition to intact immunoglobulin molecules, also included in the term “antibodies” are fragments or polymers of those immunoglobulin molecules, and human or humanized versions of immunoglobulin molecules that selectively bind the target antigen. The term encompasses intact and/or full length immunoglobulins of types IgA, IgG (e.g., IgG1, IgG2, IgG3, IgG4), IgE, IgD, IgM, IgY, antigen-binding fragments and/or single chains of complete immunoglobulins (e.g., single chain antibodies, Fab fragments, F(ab′)2 fragments, Fd fragments, scFv (single-chain variable), and single-domain antibody (sdAb) fragments), and other proteins that include at least one antigen-binding immunoglobulin variable region, e.g., a protein that comprises an immunoglobulin variable region, e.g., a heavy (H) chain variable region (VH) and optionally a light (L) chain variable region (VL). The light chains of an antibody may be of type kappa or lambda.

An antibody may be polyclonal or monoclonal. A polyclonal antibody contains immunoglobulin molecules that differ in sequence of their complementarity determining regions (CDRs) and therefore, typically recognize different epitopes of an antigen. Often a polyclonal antibody is derived from multiple different B cell lines each producing an antibody with a different specificity. A polyclonal antibody may be composed largely of several subpopulations of antibodies, each of which is derived from an individual B cell line. A monoclonal antibody is composed of individual immunoglobulin molecules that comprise CDRs with the same sequence, and, therefore, recognize the same epitope (i.e., the antibody is monospecific). Often a monoclonal antibody is derived from a single B cell line or hybridoma. An antibody may be a “humanized” antibody in which for example, a variable domain of rodent origin is fused to a constant domain of human origin or in which some or all of the complementarity-determining region amino acids often along with one or more framework amino acids are “grafted” from a rodent, e.g., murine, antibody to a human antibody, thus retaining the specificity of the rodent antibody.

In some embodiments, the recognition element can comprise Surface Enhanced Raman Spectroscopy (SERS)-active nanostructured metal. In further embodiments, the SERS-active nanostructured metal can comprise metal nanoparticles. In specific embodiments, the metal comprises a metal selected from the group consisting of Ru, Rh, Pd, Os, Ir, Pt, Au, Ag, Cu, Al, and combinations thereof. In certain embodiments, an antibody, antibody fragment, antibody mimetic, peptide, oligonucleotide, DNA, RNA, aptamer, organic molecule, or any combination thereof is associated with the SERS-active nanostructured metal. In some embodiments, the antibody, antibody fragment, antibody mimetic, peptide, oligonucleotide, DNA, RNA, aptamer, organic molecule, or any combination thereof is covalently bound to the SERS-active nanostructured metal.

In certain embodiments, the recognition element comprises an immunoglobulin G (IgG) antibody, a single-chain variable fragment (scFv), or a single-domain antibody (sdAb). In certain embodiments, the recognition element comprises a receptor, such as a soluble receptor, for use in detecting ligands of the receptor as the analyte.

In some embodiments, the recognition element comprises an antigen or antigenic hapten. In certain embodiments, the antigenic hapten is not biotin or a derivative thereof. Any suitable antigen can be used. For example, the antigen can be viral antigens, bacterial antigens, tumor antigens, tissue specific antigens, fungal antigens, parasitic antigens, human antigens, botanical antigens, non-human animal antigens, allergens, synthetic antigens, or combination thereof.

The chamber 110 further includes a target region 118. The target region 118 can occupy any region within the chamber 110 and can cover any fraction of the nanostructures 116. In some embodiments, the target region 118 has an area of from 5 μm to about 20 μm, or from about 6 μm to about 18 μm, or from about 7 μm to about 16 μm, or from about 8 μm to about 14 μm, or from about 9 μm to abut 12 μm, or from about 5 μm to about 9 μm, or from about 6 μm to about 8 μm, or from about 12 μm to about 20 μm, or from about 14 μm to about 18 μm. In some embodiments, the target region 118 can cover from 50% to about 90% of the nanostructures 116. In some embodiments, the target region 118 can cover all of the nanostructures 116. In some embodiments, the system further includes a spectrometer operatively positioned to interrogate the target region 118.

The light source 102 is configured to impinge electromagnetic radiation on the target region 118, which generates an electric field within the target region 118. In the exemplary device 104, the generation of this electric field is supplemented by a first conductive layer 120 disposed on the second surface 108b of the substrate 106, which serves as an electrode. In some embodiments, the first conductive layer 120 is disposed on the first surface 108a of the substrate 106. In some embodiments, the first conductive layer 120 includes a metallic layer, such as a noble metal layer. In some embodiments, the metallic layer includes silver, gold, platinum, or any combination thereof. In some embodiments, the device 104 further includes a polymer layer disposed on top of the first conductive layer 120. In some embodiments, the polymer layer includes poly(methyl methacrylate) (PMMA) or polydimethylsiloxane. The exemplary device 104 further includes a second conductive layer 122 that is optically transparent and disposed over the chamber 110. In some embodiments, the second conductive layer 122 is optically transparent. In some embodiments, the second conductive layer 122 is made from indium tin oxide (ITO) glass, fluoride tin oxide (FTO) glass, or a combination thereof. In some embodiments, the device 104 does not include a first conductive layer and/or a second conductive layer.

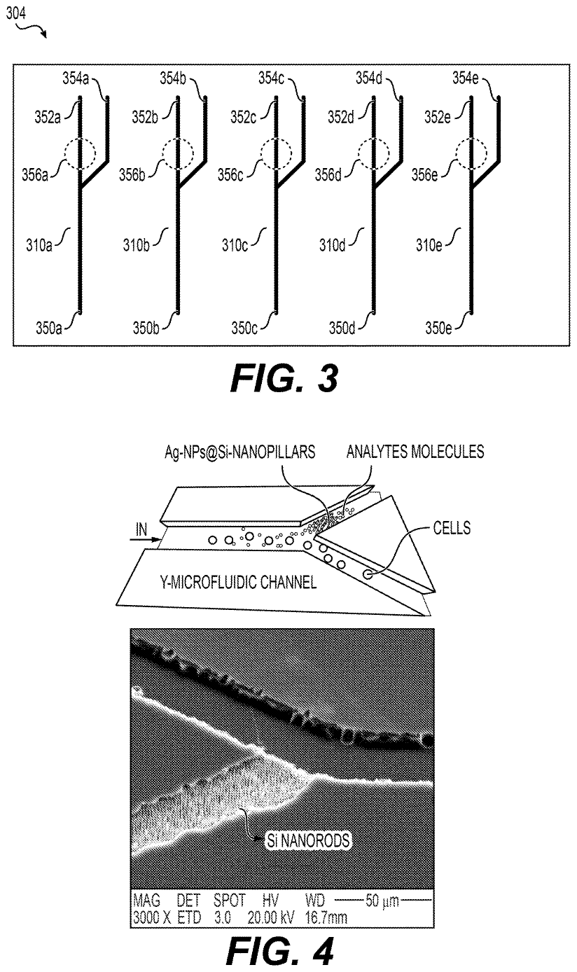

FIG. 3 shows an exemplary device 304 that is configured to simultaneously detect analytes in multiple solutions. The exemplary device includes multiple chambers 310a, 310b, 310c, 310d, 310e that are each incorporated into a multifluidic channel. Each chamber 310a, 310b, 310c, 310d, 310e has an input 350a, 350b, 350c, 350d, 350e a first output 352a, 352b, 352c, 352d, 352e and a second output 354a, 354b, 354c, 354d, 354e each of which can be connected to pumps to separately flow each solution through the chambers. The analyte in each solution can be detected by illuminating each target region 356a, 356b, 356c, 356d, 356e with a light source.

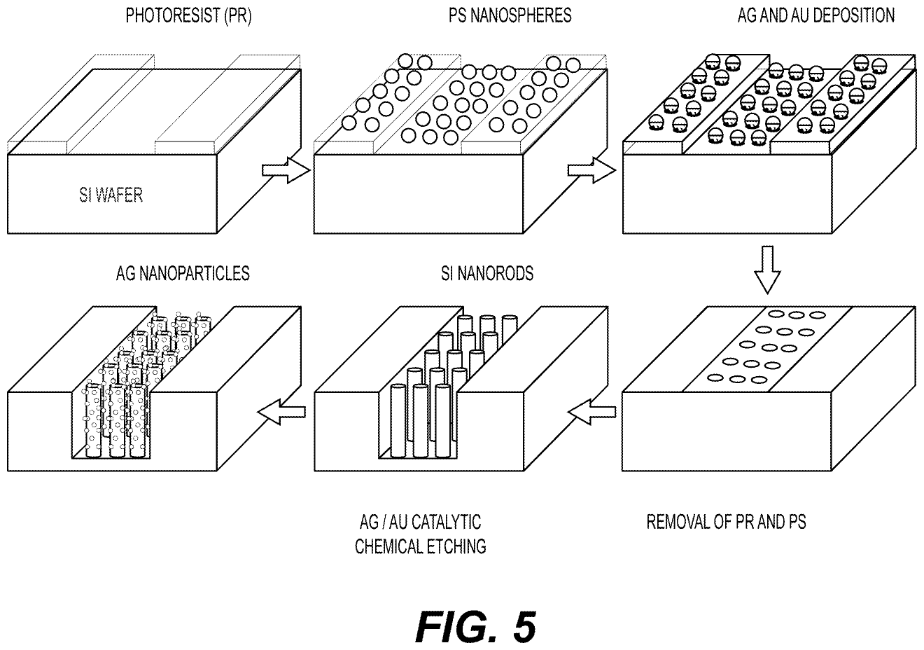

FIG. 5 shows the use of another exemplary device and SEM images of the device.

The methods described herein can be used to detect analytes in solution. In some embodiments, the analyte is present in an aqueous solution.

The analyte can be present in a biological sample. “Biological sample,” as used herein, refers to a sample obtained from or within a biological subject, including samples of biological tissue or fluid origin obtained in vivo or in vitro. Such samples can be, but are not limited to, bodily fluid, organs, tissues (e.g., including resected tissue), fractions and cells isolated from mammals including, humans. Biological samples also may include sections of the biological sample including tissues (e.g., sectional portions of an organ or tissue). The term “biological sample” also includes lysates, homogenates, and extracts of biological samples.

In certain embodiments, the analyte is present in a bodily fluid. “Bodily fluid”, as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples.

The methods described herein can be used to detect an analyte in vivo (i.e., the analyte is contacted with the device in vivo).

The methods described herein can be used to detect an analyte ex vivo (i.e., the analyte is contacted with the device ex vivo). The term “ex vivo,” as used herein, refers to an environment outside of a subject. Accordingly, a sample of bodily fluid collected from a subject is an ex vivo sample of bodily fluid. In certain embodiments, the ex vivo sample is a biological fluid, lysate, homogenate, or extract.

The methods described herein can be used to detect an analyte in vitro (i.e., the analyte is contacted with the device in vitro). Such methods can be used, for example, to monitor tissue cultures.

The analyte can be present in an environmental sample, such as a water sample or soil leachate.

The methods can be used to determine a presence of the analyte, to determine the concentration of the analyte, or a combination thereof.

The systems and methods disclosed herein require the analyte be charged. The analyte may have a net negative or positive charge, or in other embodiments, the analyte has a net neutral charge, but contains one or more charged regions such that when associated with the recognition element, an electric field is generated which modulates the electronic properties of the channel.

The analyte can comprise a macromolecule, such as a biomacromolecule. “Macromolecule,” as used herein, refers to a large molecule, typically having a high relative molecular weight, such as a polymer, polysaccharide, protein, peptide, or nucleic acid. The macromolecule can be naturally occurring (e.g., a biomacromolecule) or can be prepared synthetically or semi-synthetically. In certain embodiments, macromolecules have a molecular weight of greater than about 1000 amu (e.g., greater than about 1500 amu, or greater than about 2000 amu).

In some embodiments, the analyte is an antibody, peptide (natural, modified, or chemically synthesized), protein (e.g., glycoproteins, lipoproteins, or recombinant proteins), polynucleotide (e. g, DNA or RNA), lipid, polysaccharide, pathogen (e.g., bacteria, virus, or fungi, or protozoa), or a combination thereof. In certain embodiments, the analyte comprises a biomarker for a disease process in a patient.

The devices can also be used to detect antibodies or antigens in a sample.

The devices can be used in clinical and healthcare settings to detect biomarkers (i.e., molecular indicators associated with a particular pathological or physiological state, such as cancer). The devices can be used to diagnose infections in a patient (e.g., by measuring serum antibody concentrations or detecting antigens). For example, the devices can be used to diagnose viral infections (e.g., HIV, hepatitis B, hepatitis C, rotavirus, influenza, or West Nile Virus), bacterial infections (e.g., E. coli, Lyme disease, or H. pylori), and parasitic infections (e.g., toxoplasmosis, Chagas disease, or malaria). The devices can be used to rapidly screen donated blood for evidence of viral contamination by HIV, hepatitis C, hepatitis B, and HTLV-1 and -2. The devices can also be used to measure hormone levels. For example, the devices can be used to measure levels of human chorionic gonadotropin (hCG) (as a test for pregnancy), Luteinizing Hormone (LH) (to determine the time of ovulation), or Thyroid Stimulating Hormone (TSH) (to assess thyroid function). The devices can be used to diagnose or monitor diabetes in a patient, for example, by measuring levels of glycosylated hemoglobin, insulin, or combinations thereof. The devices can be used to detect protein modifications (e.g., based on a differential charge between the native and modified protein and/or by utilizing recognition elements specific for either the native or modified protein).

The devices described herein can also be used, for example, to detect and/or monitor the levels of therapeutic peptides in vivo. This could be used during treatment (e.g., to titrate clinically preferred levels of a therapeutic peptide) as well as during clinical trials.

The devices can be used to detect proteinaceous toxins, including mycotoxins, venoms, bacterial endotoxins and exotoxins, and cyanotoxins. For example, the devices could be used to detect botulinum toxin, ricin, tetanus toxin, C. difficile toxin A, C. difficile toxin B, or staphylococcal enterotoxin B (SEB).

The devices can also be used in other commercial applications. For example, the devices can be used in the food industry to detect potential food allergens, such as milk, peanuts, walnuts, almonds, and eggs. The devices can be used to detect and/or measure the levels of proteins of interest in foods, cosmetics, nutraceuticals, pharmaceuticals, and other consumer products.

The devices can be used in the biotechnology industry to measure the concentration of biomolecules, such as antibodies, during manufacture.

The devices described herein can be integrated into devices to facilitate the detection of analytes in vivo, ex vivo, and in vitro. For example, the devices described herein can be integrated into a variety of existing medical devices, research instruments, and vessels (e.g., micro-well plates) to provide a real-time capability for rapidly and accurately assaying the presence of one or more analytes.

The methods and compositions of the appended claims are not limited in scope by the specific methods and compositions described herein, which are intended as illustrations of a few aspects of the claims and any methods and compositions that are functionally equivalent are intended to fall within the scope of the claims. Various modifications of the methods and compositions in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1: Device Fabrication

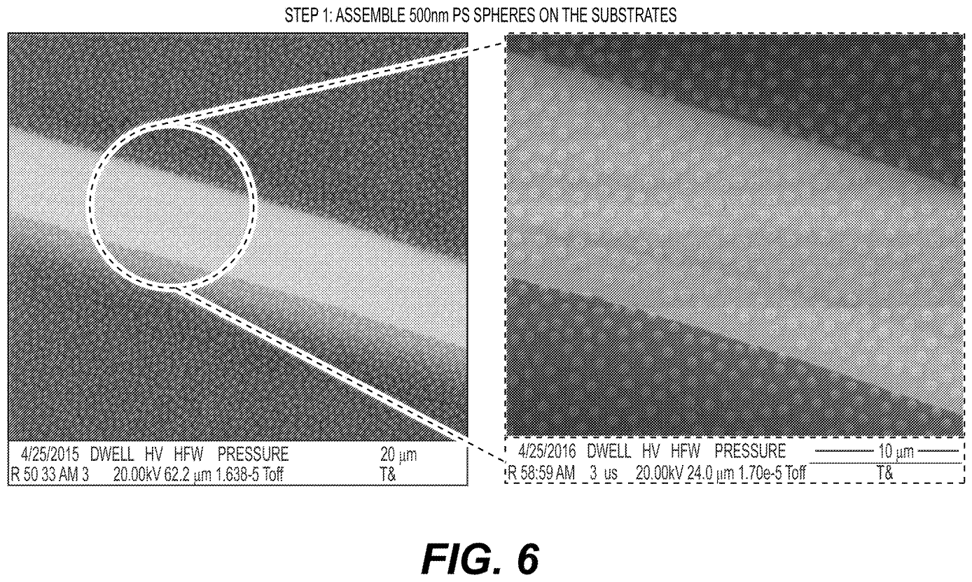

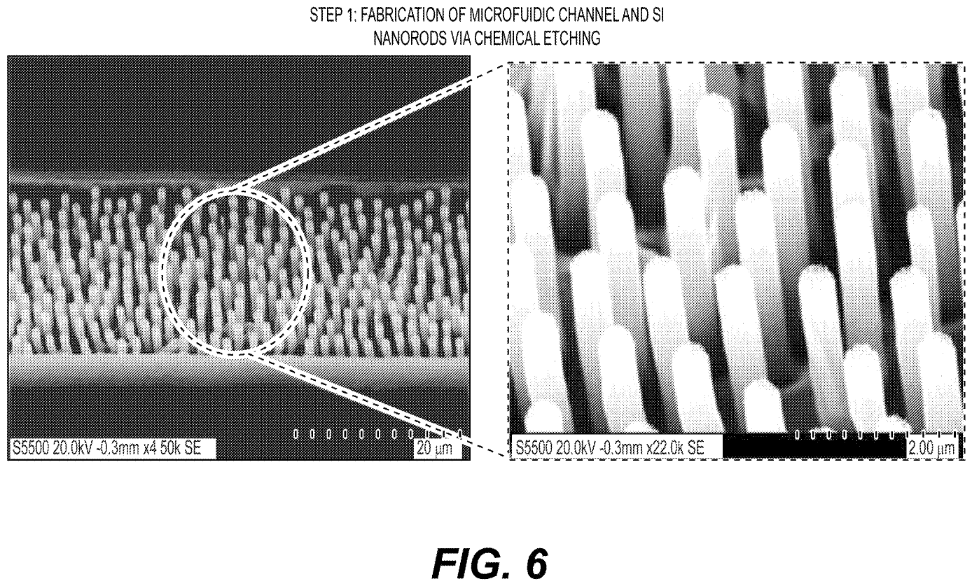

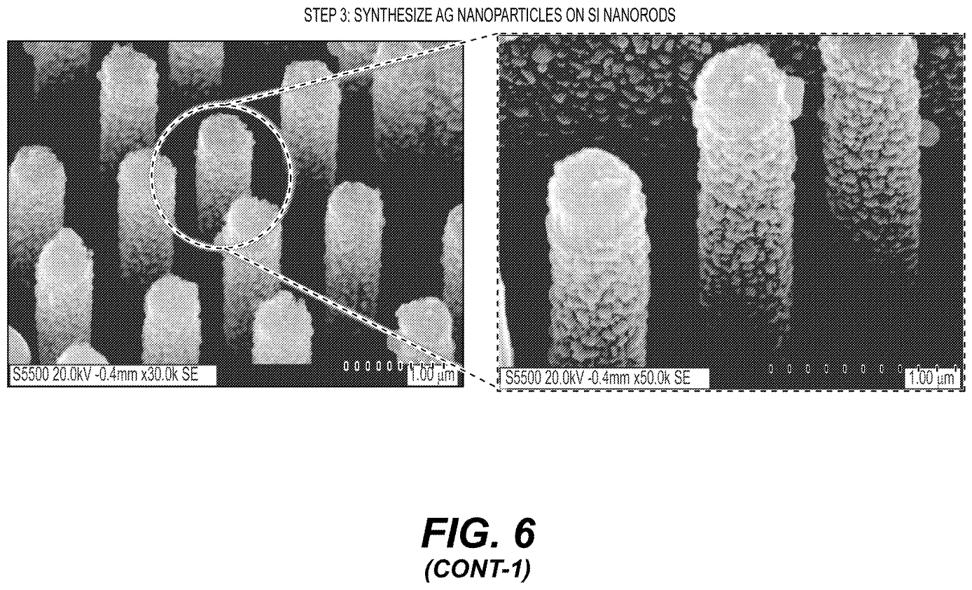

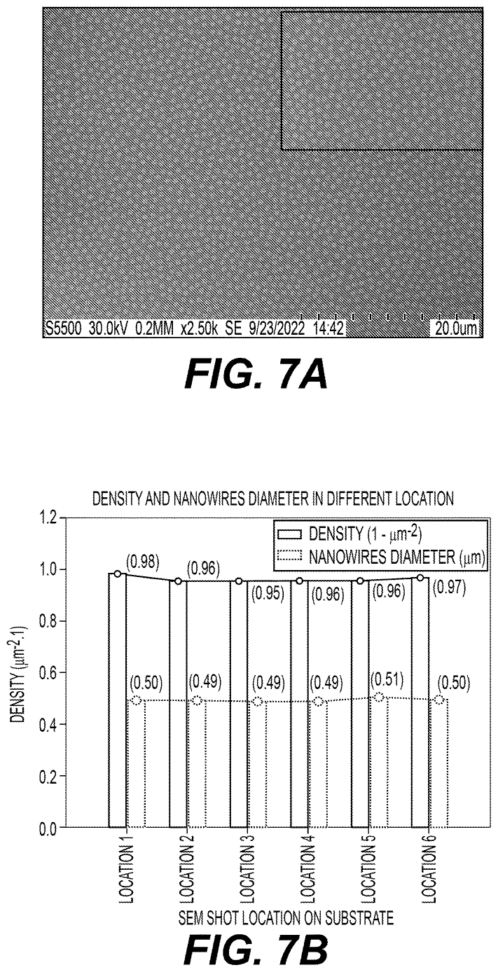

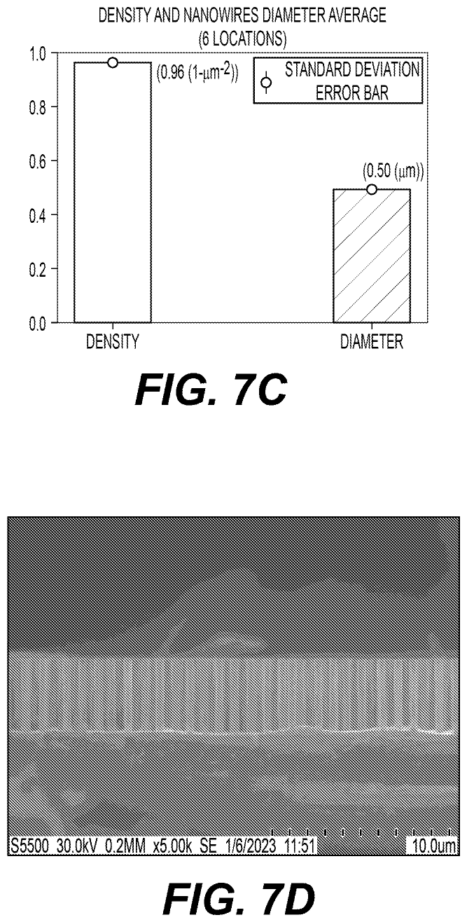

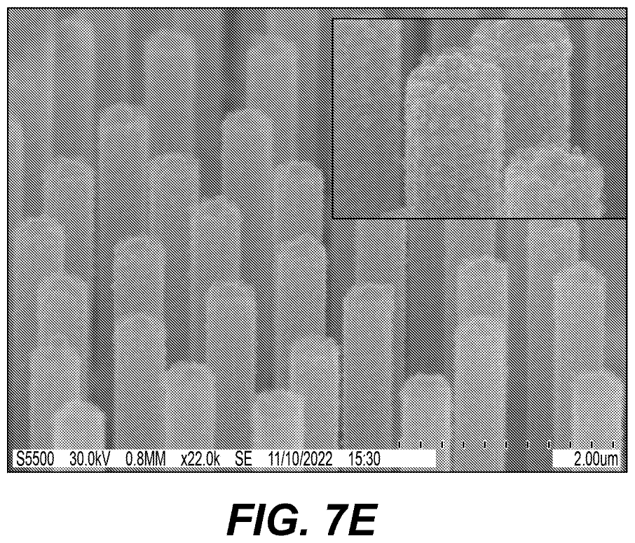

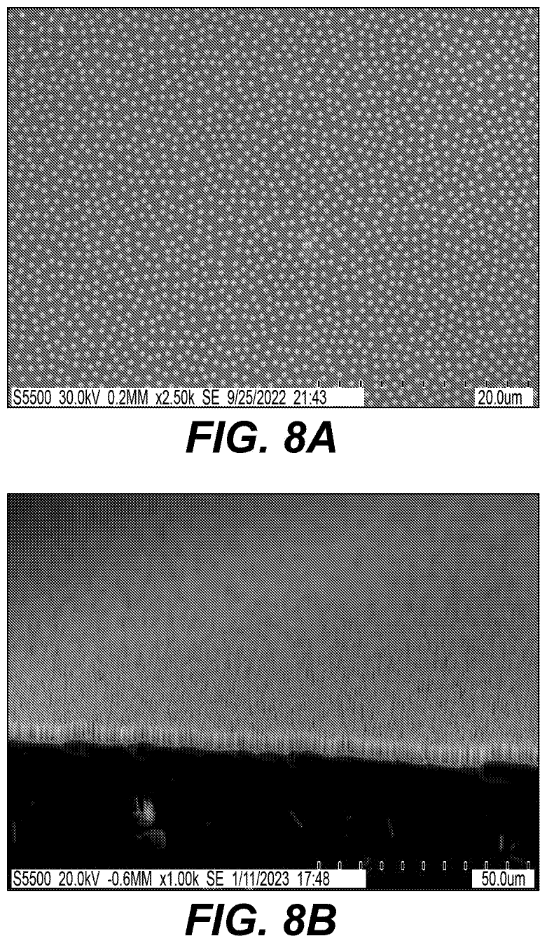

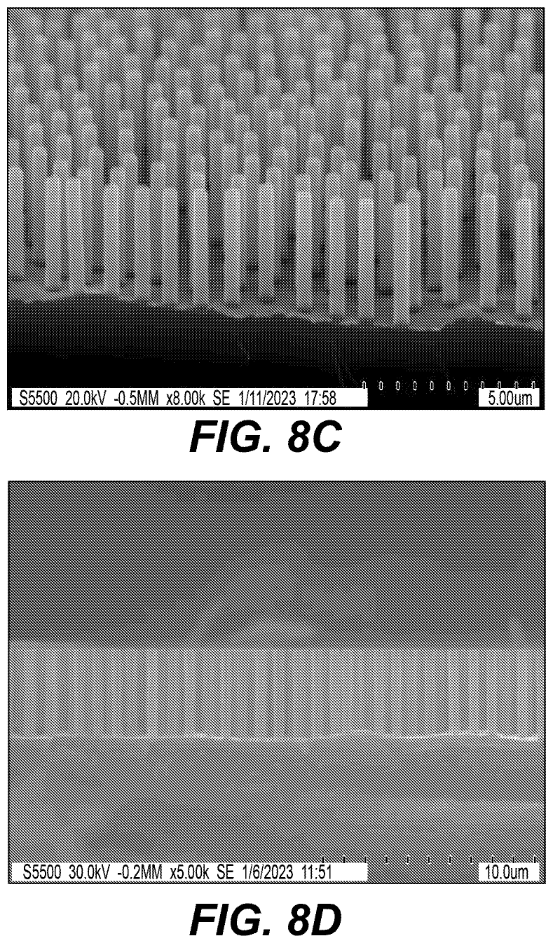

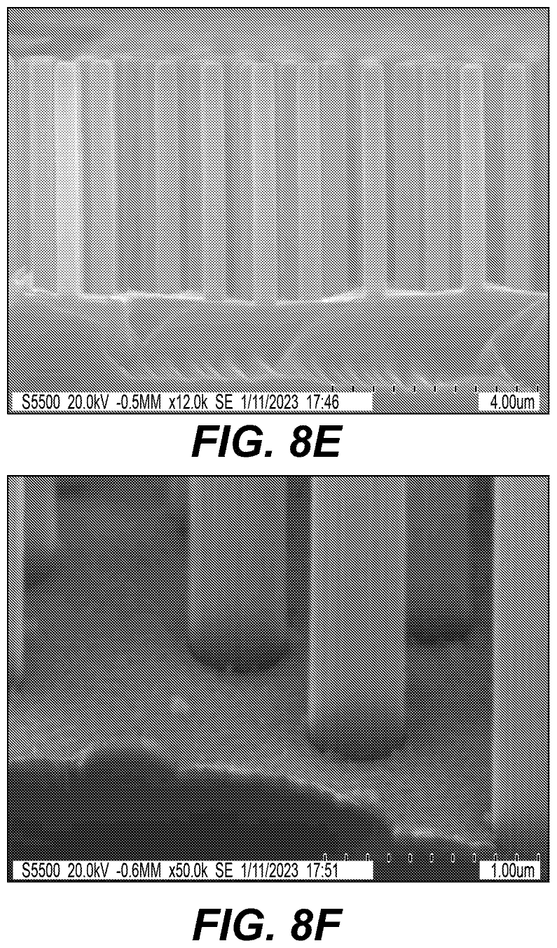

Fabrication of Silicon Nanorods Array: To establish a high-density silicon nanowire array, a procedure was executed. First, a dense and sufficiently uniform assembly of Polystyrene (PS) spheres was achieved through a self-assembly process on a silicon wafer (UniversityWafer, Inc., Undoped Si with orientation of <100> and resistance of 2000 Ω·cm) as shown in FIG. 5 and FIG. 6. This was accomplished by strategically applying a charged polymer triple layer (PDDA+PSS+ACH) and modifying the surface with positive charges by immersion in poly(diallyldimethylammonium chloride) (PDDA, 4 wt %), poly(sodium 4-styrenesulfonate) (PSS, 4 wt %), and aluminum chlorohydrate (ACH, 10 wt %) sequentially. The wafer was electrostatically coated by a monodispersed layer of polystyrene (PS) nanospheres (Alfa Aesar, diameter 500 nm). This process resulted in the sufficiently uniform deposition of PS spheres at an average density of 0.96 spheres/μm² on the silicon wafer, as evident in FIGS. 7A-7C. Subsequently, a multilayered film composed of a 3 nm Aluminum (Al) layer, a 20 nm Silver (Ag) layer, and a 10 nm gold (Au) layer, was deposited onto the PS sphere-covered surface using electron beam sputtering. Following this, the PS sphere structure was delicately removed using chloroform and a 5-minute sonication process, followed by rinsing steps in ethanol and deionized water, each lasting 5 minutes. The resulting metal template could then be employed as a substrate for the fabrication of the nanowire array structure. Etching of the silicon substrate was achieved using the mixture of hydrofluoric acid (HF, 5.0 M) and hydrogen peroxide (H₂O₂, 0.15 M). Notably, a consistent etching speed was maintained throughout this process, and a linear relationship between silicon wire length and etching time was observed. This etching process yielded sufficiently uniform silicon etching, as evident from the defined etching edge showcased in FIG. 7D and FIGS. 8B-8E.

Synthesis of Plasmonic Ag Nanoparticles: To facilitate the subsequent growth of dense silver particles, the etched silicon substrates were dried using a nitrogen gun and allowed to stand at room temperature for a duration of two days. This step ensured the appropriate preparation of the substrate for the subsequent silver particles growth process. Utilizing an ethanol solution of Polyvinylpyrrolidone (PVP), the silver particles were synthesized via the catalytic reduction of silver nitrate (AgNO₃). The synthesis process was initiated by immersing the nanorods wafer within a mixture of AgNO₃ (0.06M, 1.5 ml) and ammonia (0.06M, 1.5 ml), and then the whole mixture was shaken for 1 hour. Following this, a 2.4 ml aliquot of the mixture solution was extracted, to which 10 ml of the PVP solution (2.5×10⁻⁵ M in ethanol, Molecular Weight 40,000) was introduced. After 7 hour reaction at 70° C., dense Ag nanoparticles were synthesized on the Si nanorods. Densely distributed and isolated silver particles were successfully grown across the surface of the nanowire array. Finally, after rinsing in ethanol and D.I. water, the microsensors based on diatom frustules were prepared.

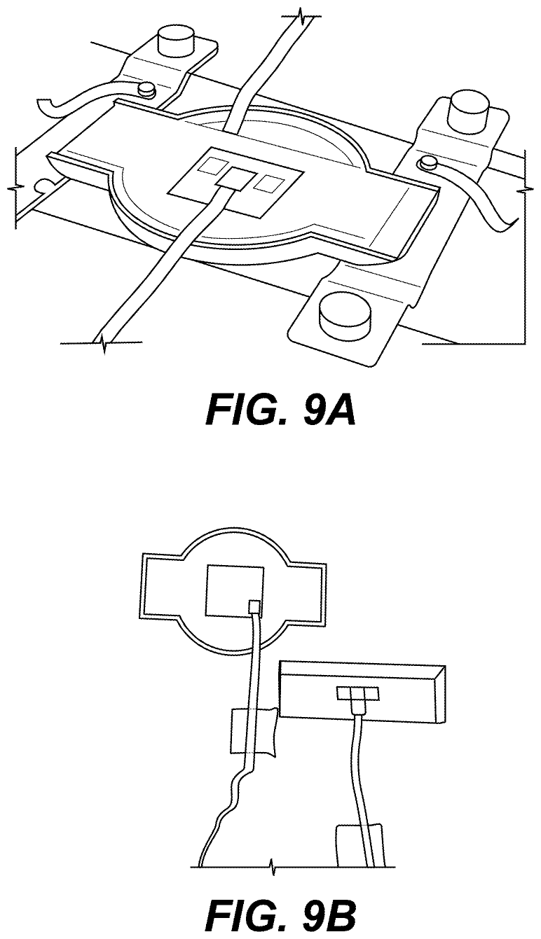

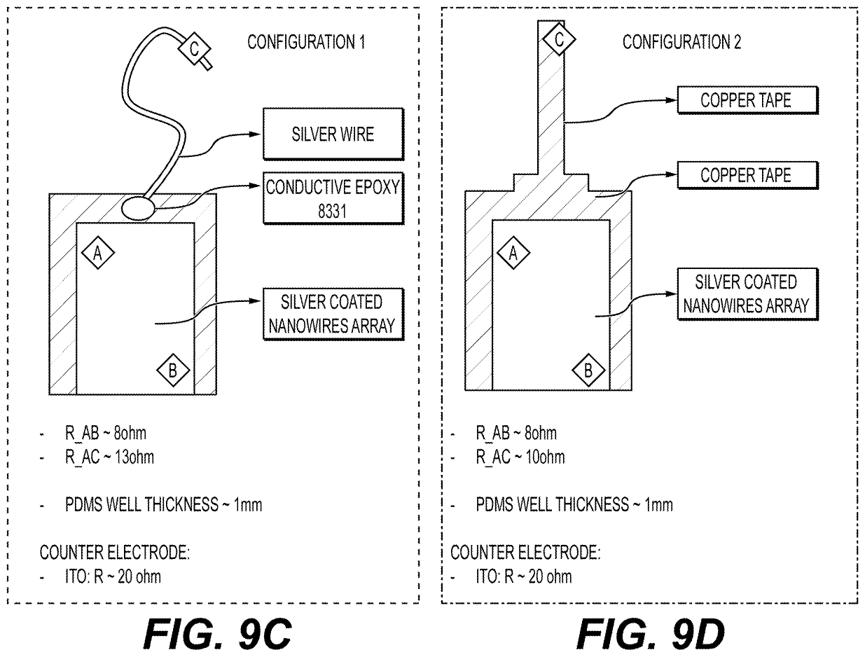

SERS characterization: The fabricated device was tested according to the experimental setup in FIGS. 9A-9G. Adenine was dissolved in the commercial phosphate-buffered saline (PBS) solution and then sealed in a polydimethylsiloxane (PDMS) microwell (3 mm in diameter) on top of the Si wafer by an indium tin oxide (ITO) glass for the SERS measurements. The voltage (provided by Agilent 33250A function generator) was applied on the metallic film (working electrode) and the ITO glass (counter electrode). The distance between two electrodes was determined by the thickness of PDMS microwell, ranging from 100 μm to 2 mm. The SERS characterizations were carried out on an Olympus IX80 inverted microscope. A 532 nm laser with a spot of ˜7.6 μm and power of 500 μW was used. The SERS signals were detected by Acton 2500 spectrometer (Princeton Instruments, Inc). The exposure time for each test was 10 seconds.

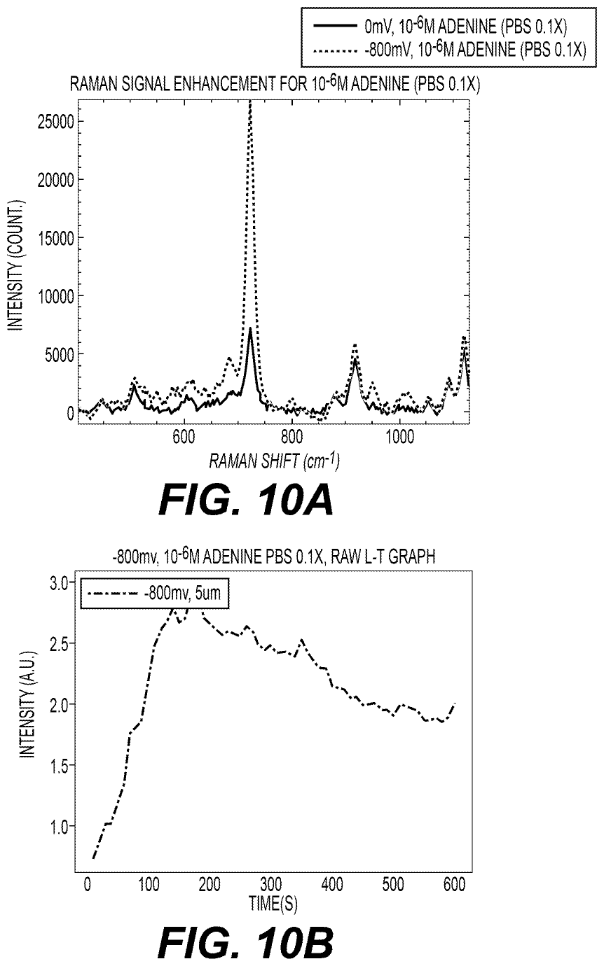

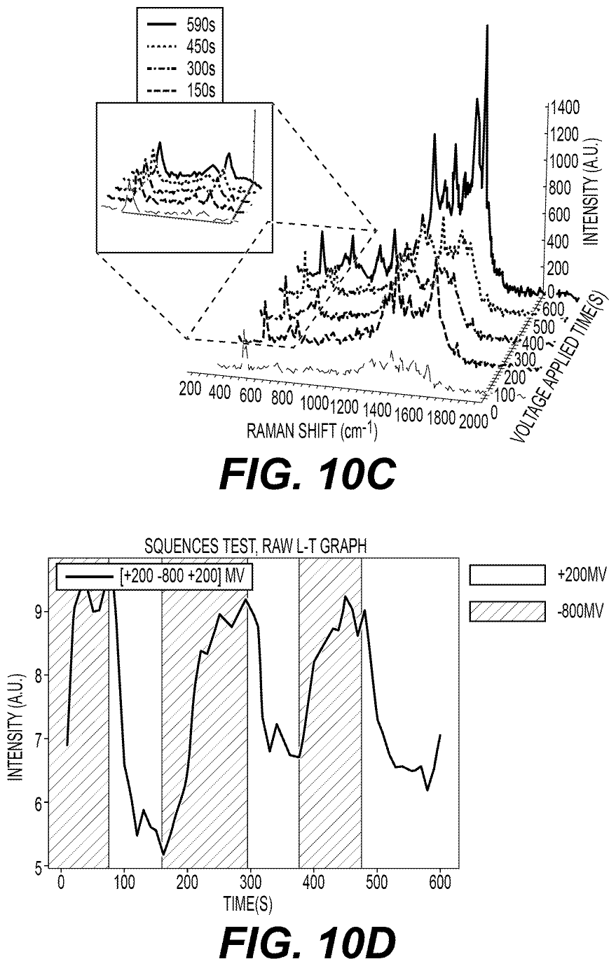

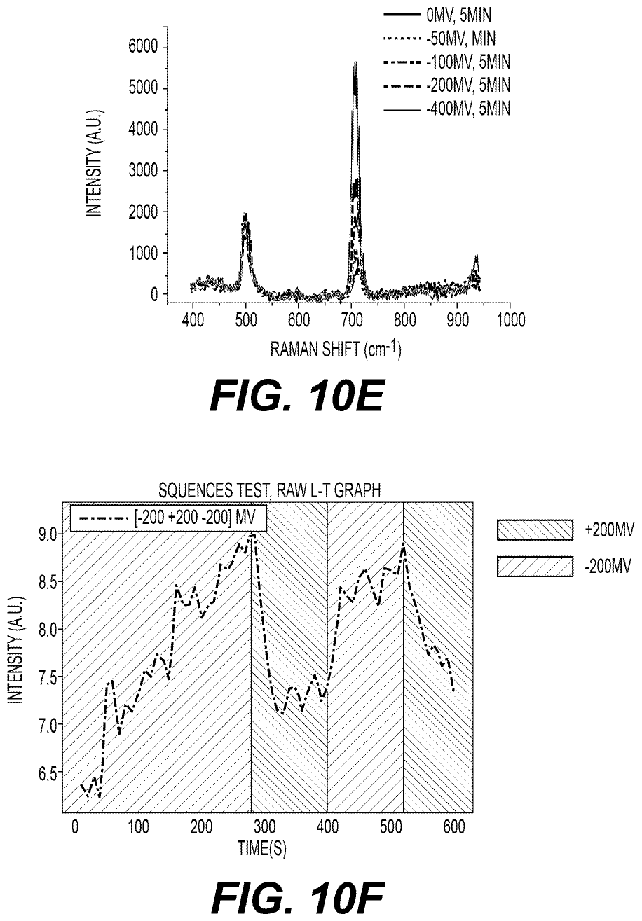

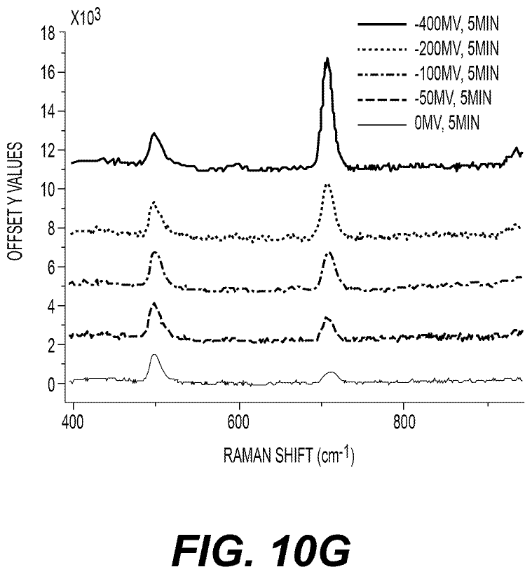

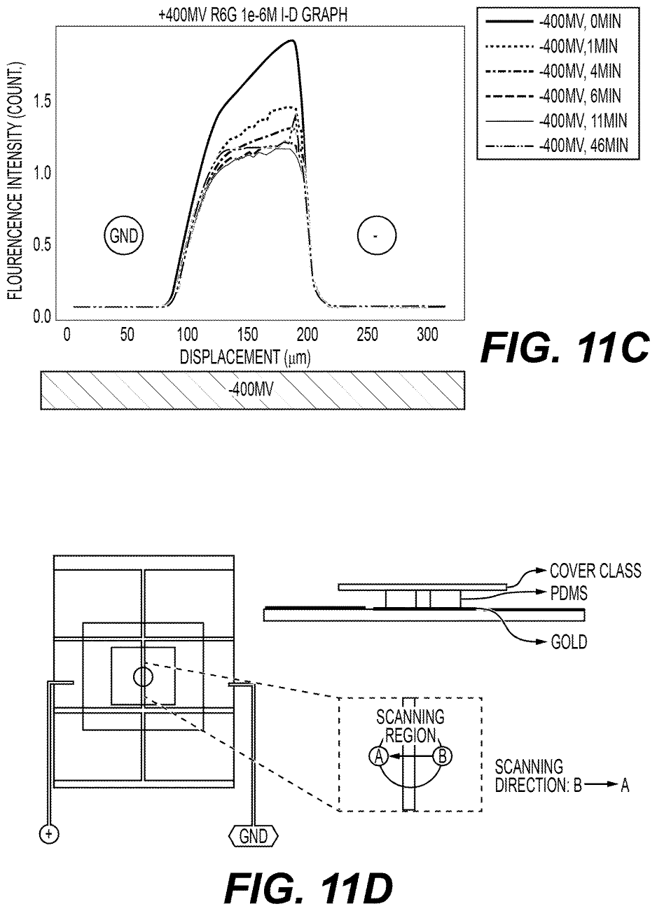

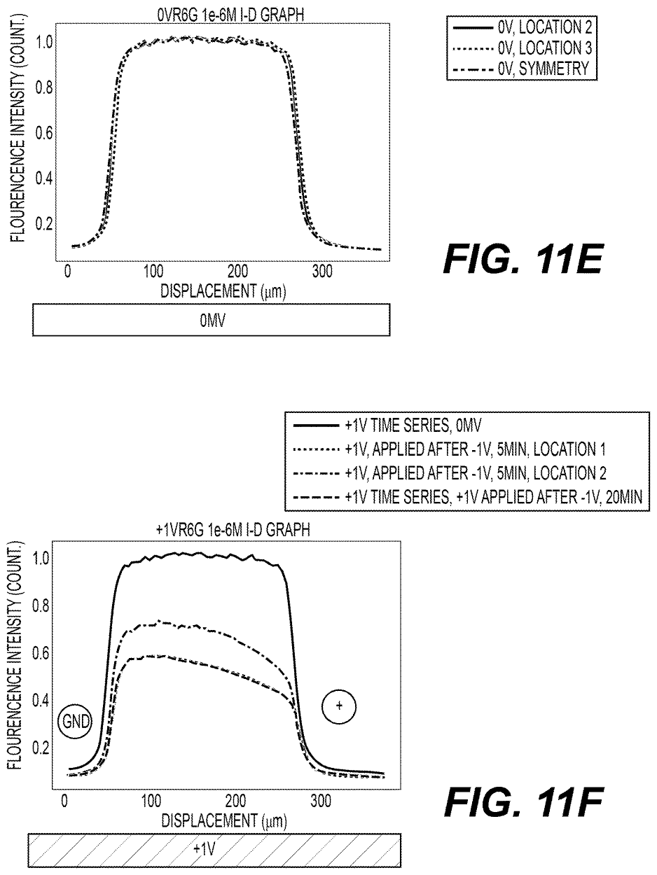

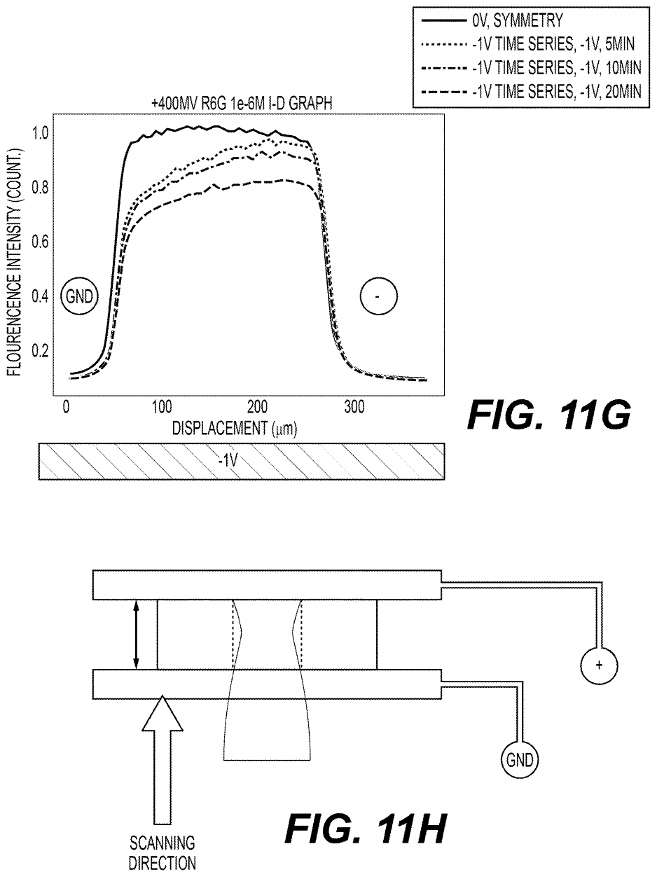

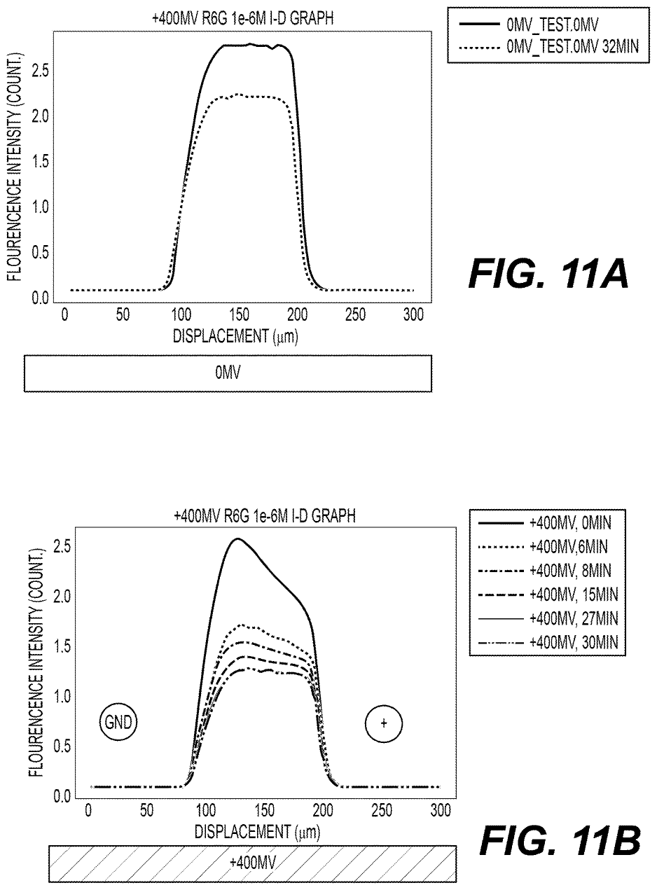

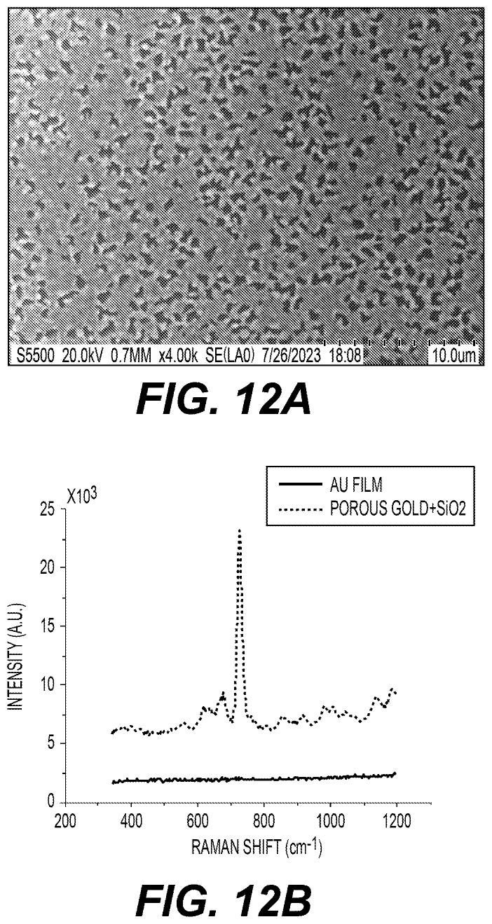

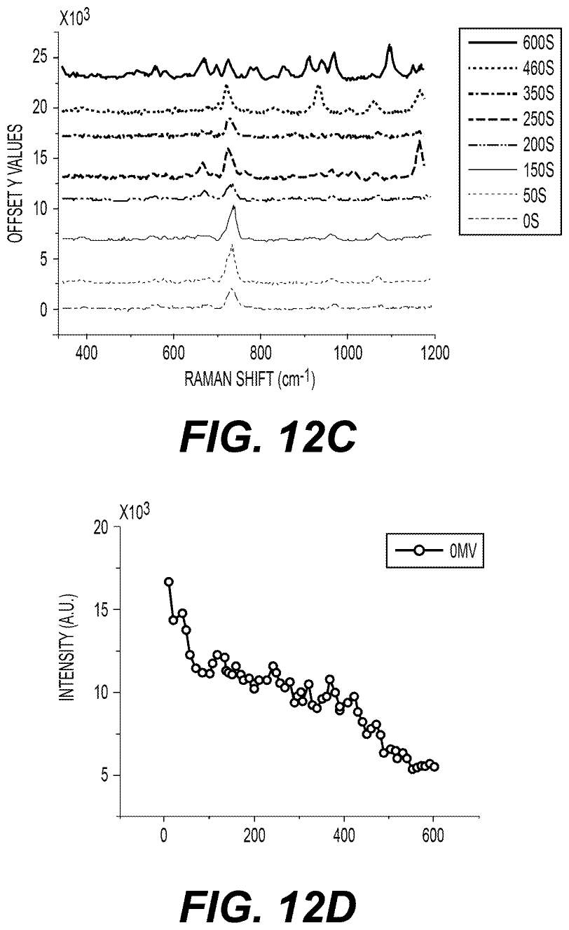

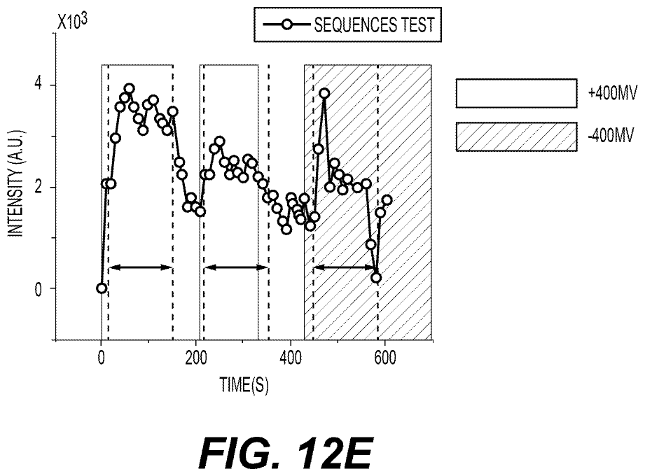

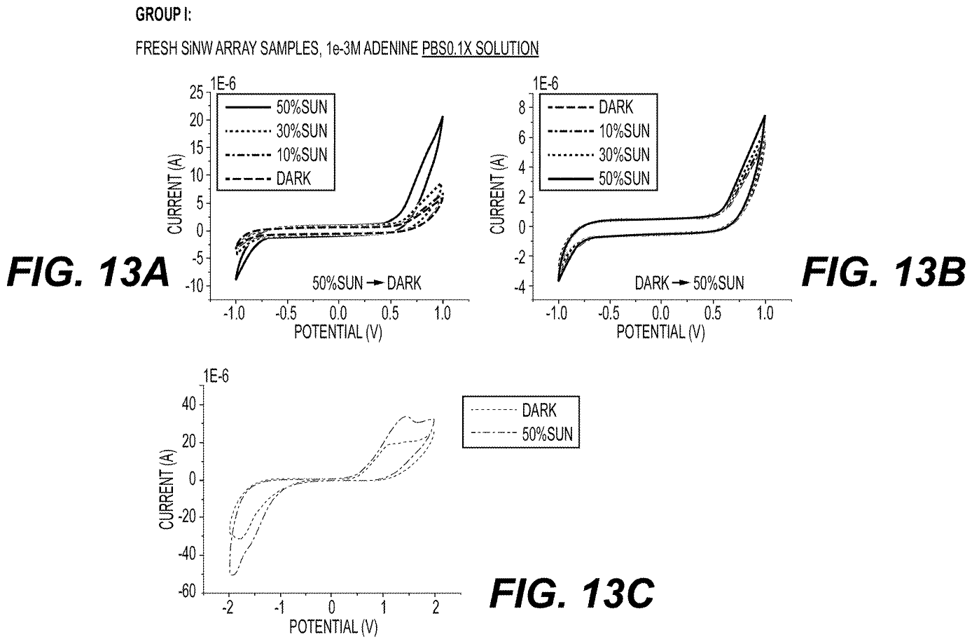

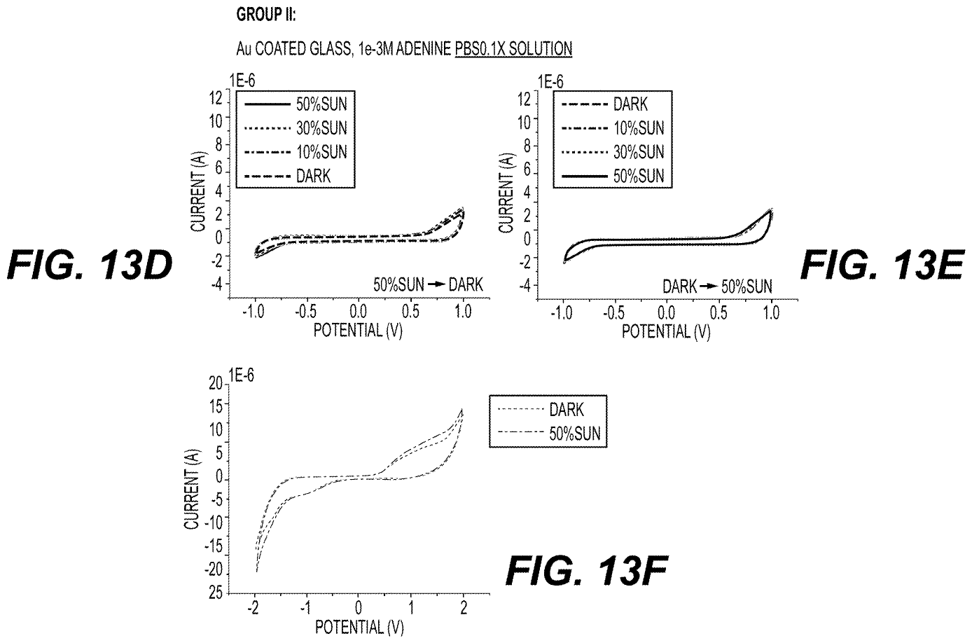

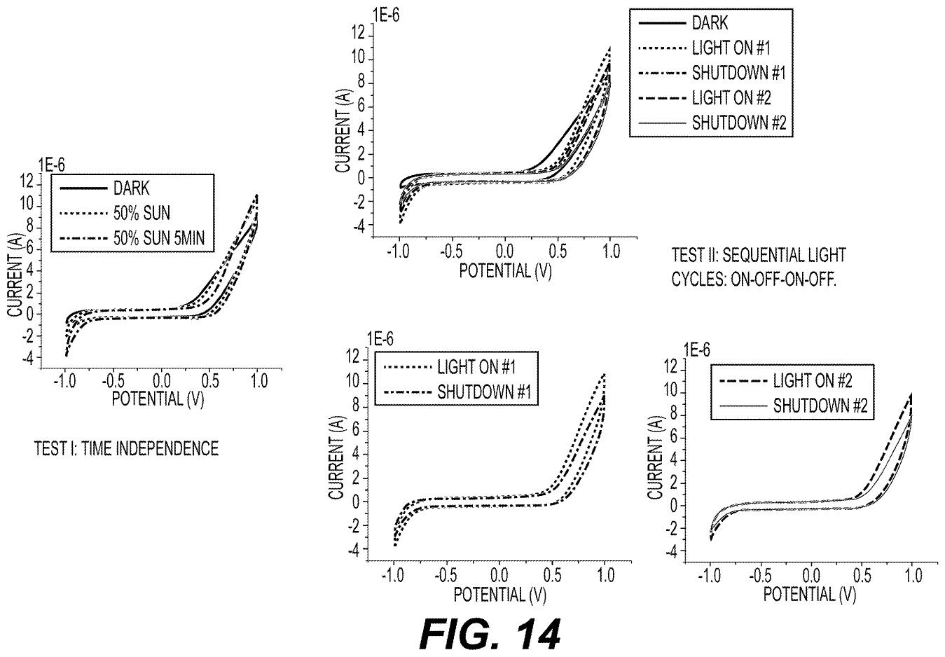

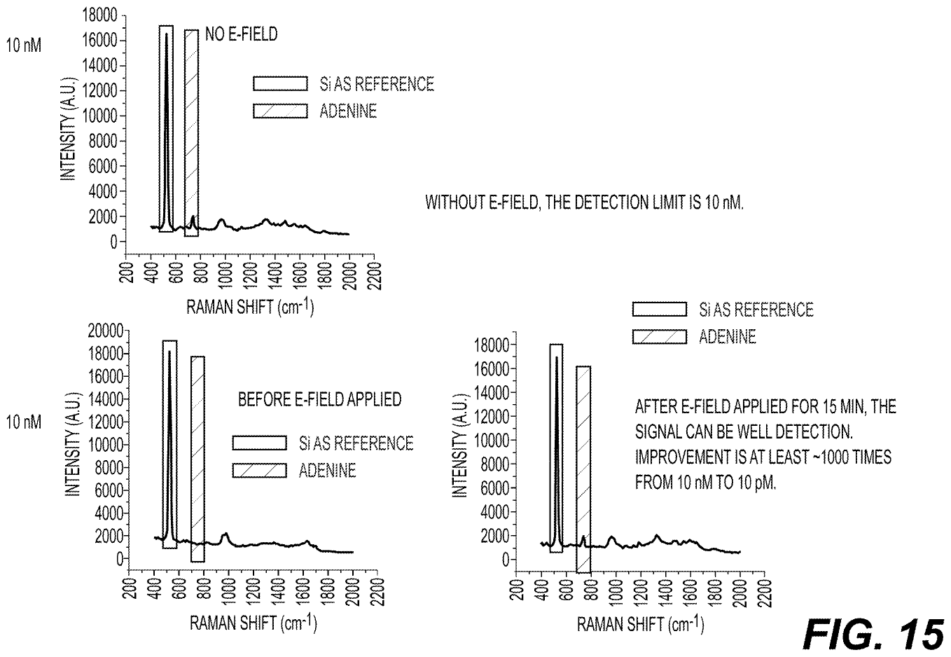

FIGS. 9A-9G shows SERS signals of adenine molecules in response to applied voltages, indicating that electric voltages generated from Si nanorods can enhance detection. FIGS. 10A-10F and FIGS. 11A-11E show that application of E-voltages can readily enhance the concentrations of various molecules near electrodes of suitable electric polarity as observed from the enhanced fluorescent signals of R6G molecules near ITO electrodes (FIGS. 10A-10F), as well as nanoporous Au, which serve as both electrodes and a SERS substrate for adenine molecules (FIGS. 11A-11E). FIGS. 12A-12F and FIG. 13 show the results of testing a cyclic voltogram from Si nanowires with and without light illumination, which shows that light can effectively enhance electric conductivity of Si and let them participate in electrochemistry.

### Example 2: Device Design & Rational Fabrication

The proposed on-chip platform can be created based on an optoelectric plasmonic-sensitive substrate made of high-density single-crystalline Si nanorods with surface-distributed Ag nanoparticles (NPs) standing in an array of branched microchannels. The microchannels can be sealed by a conducting Indium-tin-oxide (ITO) glass. Owing to the blocking effect of the dense Si nanorods, the microchannels can readily filtrate cells and tissue debris prior to the detection. An electric field will be applied between the ITO glass (covering the top of the chip) and the Au/Cr thin-film electrode on the back of the ultrathin intrinsic Si substrate. As a result, only at the point of laser-illumination, the single-crystal Si nanorods with high photoconductivity can become conducting and generate high-intensity localized electric field for the manipulation and aggregation of low-concentration biomarkers. Under the same light, the enriched molecules can be detected from the Si nanorods; here, the Si nanorods are sensitized by high-density plasmonic Ag NPs, which facilitate the conjugation of capture-antibodies and enhance fluorescence detection.

Facile, Strategic Fabrication with High Reproducibility: To fabricate the proposed multifunctional platform rationally and reproducibly, a strategical one-step catalytic etching approach can be exploited to sculpture dense single-crystalline Si nanorods directly integrated in microchannels from an ultrathin intrinsic Si substrate (100 μm±10) (University Wafer Inc).³⁸ The nanorods and the microchannels can be made simultaneously with this single-step etching process. The fabrication also permits the tuning of the nanorod arrays with controlled diameter, length, and density as shown in FIG. 5.

Specifically, the fabrication can start with patterning the areas of the parallel microchannels with photoresist on the silicon wafer. Here, silicon wafers with various doping levels can be explored along with a systematic tuning of the dimension of the Si nanorods to optimize their opto-electric conductivities for light-controlled molecule congregation in an electric field.

To synthesize the Si nanorods, monodispersed polystyrene (PS) nanospheres can be electrostatically assembled on the exposed areas of the photoresist that define the channels; the size of the nanospheres can be tuned from 100 to 500 nm with controlled densities. This effort is also desirable to obtain an optimal sample-processing efficiency when separating cells and tissue debris in the branched microchannels. Next, a Au/Ag thin film (10 nm/10 nm) can be electron-beam evaporated on top of the nanospheres followed by dissolving the spheres and the photoresist in toluene and in acetone, respectively. As a result, a parallel array of Au/Ag microribbons with monodispersed nanoholes can be formed on the Si.

The as-obtained Au/Ag microribbons can be utilized as catalysts to selectively etch the covered areas of Si in a mixed solution of hydrofluoric acid (HF, 5.0 M) and hydrogen peroxide (H₂O₂, 0.15 M).^{28,39} Therefore, single-crystal Si nanorods standing in the microchannels can be created in only one step. This monolithographic process permits the simultaneous fabrication of microchannels and their embedded Si nanorods.

After removing the Au/Ag catalysts with commercial Au and Ag etchants (Transene Company Inc.), high-density plasmonic Ag NPs can be grown on the Si nanorods via polyvinylpyrrolidone (PVP)-catalyzed hydrothermal reduction.¹⁸⁻²¹ By tuning the reaction parameters, the average diameter of Ag NPs can be optimized to 30-50 nm. At this condition, an electric-field amplification factor of >102 can be obtained to substantially enhance the fluorescent detection of various biomarkers.¹⁸⁻²¹

Finally, an integrated multi-functional on-chip sensing platform can be assembled made of an ITO glass covering on the top of the Si substrate.

Fabrication of Dense Si Nanorod Arrays in Microchannels: A combined photolithography and colloidal lithography approach was examined to define the size features of the microchannels and Si nanorods, respectively. Specifically, first, a microchannel of 10 μm in width made of photoresist (MICROPOSIT S1811) was patterned on the Si wafer (undoped <100> Si). Then the exposed Si surface in the microchannel defined by the photoresist was modified with positive charges by three-layer polyelectrolyte coating via sequential immersion in poly(diallyldimethylammonium chloride) (PDDA, 4 wt %), poly(sodium 4-styrenesulfonate) (PSS, 4 wt %), and aluminum chlorohydrate (ACH, 10 wt %), followed by electrostatic assembly of negatively charged PS nanospheres (diameter 500 nm). Next a Au(10 nm)/Ag (20 nm) thin film was deposited. To ensure its direct contact with Si for the following catalytic etching, oxygen plasma was applied to remove the polyelectrolyte before the metal deposition. Then the photoresist and PS nanospheres were dissolved by sonication in acetone, successfully resulting in a nanoporous Ag/Au microribbon. The porous Ag/Au microribbon served its design purpose by catalyzing the etching of the areas of Si in contact in HF/H₂O₂ solution (5.0 M/0.15 M), producing large arrays of silicon nanowires standing in a microchannel. Thus, suitable high-density Ag NPs were grown on the surface of the Si nanowires.

### Example 3: Light-Pinpointed Molecule Aggregation for High-Speed and Ultra-Sensitive Detection

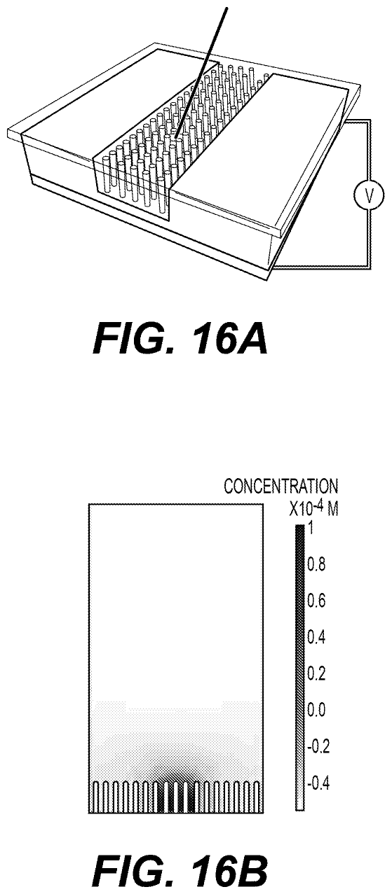

To address the daunting challenge in the detection of low-concentration biomarkers with both high speed and ultra-sensitivity, the concept of using plasmonic-sensitized Si nanowires that work as both optical sensors and light-controlled “electric rods” that, upon light illumination, conduct applied electric voltages and thus concentrate biomarkers to their surfaces can be investigated. Here the electric voltage will be applied between the ITO cover glass and the metal electrode at the back of the ultrathin Si substrate (FIG. 16A). This research is inspired by our recent finding of efficient aggregation of DNA nucleotides on light-illuminated Si that can remarkably increase the detection limit by three orders of magnitude, from 10 nM to 10 pM, at a retained signal/noise ratio (patent disclosure UT-Tech ID 7491 FAN). The feasibility is also based on the remarkable optoelectric conductivity of Si. As shown by calculations, a focused laser with a modest intensity (e.g., 532 nm, 200 mW/cm²) can instantly increase the electric conductivity of intrinsic Si nanowires (500 nm in diameter, >5000 ohm·cm) by 100 to 1000 fold.^{28,29}

Mechanistic Understanding with Systematic Experimentation and Simulation: Previous work has shown that biomolecules in suspension can efficiently congregate to microelectrodes in an applied electric field, such as to the tips of Au nanowires.⁴⁷ Here, Si nanorods in a microsize region defined by a laser spot can be electrically activated. This small activation area can synergize with the so-called lightning-rod effect endowed by the longitudinal Si nanorods to intensify the electric fields at the tips of the light-illuminated Si nanorods.⁴³ As a result, a localized ultrahigh electric field can be created to aggregate molecules in suspension. The electric-field-generated forces could range from dielectrophoresis (DEP) due to the interaction between polarized molecules and an AC field,⁴⁴ electrophoretic force that attracts biomolecules to electrodes in a DC field,⁴⁵ electroosmosis that creates circulating flows near a microelectrode in a DC or low-frequency AC field,⁴⁶ and a combined aforementioned effects. The exact working mechanism depends on the applied electric fields, as well as the electronic properties of both the biomarkers, such antibodies, cytokines, and the suspension medium.

To unravel the working mechanism for optimized high-efficiency molecule aggregation, theoretical calculation, simulation, and systematic experimental study can be carried out. For the theoretical analysis, the light-absorption efficiency and optoelectric conductivity of Si nanorods can be simulated and calculated, respectively, by varying the doping type, level, dimension, and physical arrangement of the nanorods, along with various electric-field manipulation conditions.

Experiments can test these theoretical results. Various Si nanorods arrays can be fabricated for an optimized light-controlled electric switching. A series of AC, DC, and combined AC/DC electric fields at different frequencies (0-10 MHz), amplitudes (2-30V), and bias voltages (±0.5 to ±2V) can be tested on the sensing platform. The real-time fluorescent signals can be collected from tested molecules, e.g., standard dye molecules such as Alexa Fluor 647, and dye-conjugated autoantibodies, such as Alexa-Fluor-647 tagged Anti-human IgG (709-605-149) utilized in the detection of lung-cancer biomarker EPB41L3 to reveal the dynamics of molecule aggregation and their potentially selective enrichment. The results can be carefully analyzed to fully understand the optoelectric effect, which also can add new knowledge and technical tools for research in the field of biosensing.

Preliminary Results: Numerical simulations support the validity of the optoelectric-molecule-focusing concept. For simplicity, a 2D model was utilized with the length, diameter, and interspace of Si nanorods defined as 5 μm, 500 nm, and 1 μm, respectively (FIG. 16B). The distribution profile of molecules was obtained with COMSOL (3.5a). A DC electric voltage of −0.8V and 532-nm laser (50 mW, 5 μm spotsize) were considered. Adenine, a DNA nucleotide base with an initial concentration of 10⁻⁶ M was tested in the simulation. The diffusivity is ˜1.0×10⁻⁹ m²/s.⁴⁷ It can be readily found that along the length of the light-illuminated Si nanorods, the molecule concentration is augmented by at least 100 fold from the roots to ⅗ of the height of the Si nanorods, and more than 53 fold at the tips (FIG. 16B). In contrast, molecules in the rest of the area remain dilute.

### Example 4: Validation With Biomarkers in Biofluid: Detect Multiplex Trace-Amount Biomarkers of Lung Cancer

The light-pinpointed molecule aggregation technique can be facilely applied during all the processes involving the functionalization, capture, and conjugation of the capture antibodies, targeted biomarkers, and fluorescent reporting antibodies of a panel of lung-cancer biomarkers. Multiplex biomarker detection can be carried out with the chip, each in a separation microchannel.

As aforementioned, all the functionalization and conjugation process can be conducted with the light-directed focusing technique where the sensing platform not only bestows rapid sensing of a targeted biomarker, but also greatly lowers the levels of required reagents. Note that the biomarkers specifically bind to both the capture and probing antibodies forming sandwich structures that effectively bring the reporting antibodies closely to the plasmonic surface of the plasmonic-active Si sensors, which also provides fluorescent enhancement for detection. Both the minimum detection time and time-dependent intensity of signals can be evaluated systematically for the biomarkers of different concentrations, light intensity, and electric fields. Finally, the results can be quantitatively evaluated and compared with those obtained by the ELISA technique.

This effort can demonstrate and validate the proposed nanosensing platform and determine its augmentation in sensitivity and efficiency in the quantitative detection of a panel of biomarkers of lung cancer, which is difficult to be diagnosed at an early stage.

### REFERENCE LIST

1. Lampe, Paul.
2. Nie, S. & Emory, S. R. Probing single molecules and single nanoparticles by surface-enhanced Raman scattering. Science (80-.). 275, 1102-1106 (1997).
3. Vollmer, F. & Arnold, S. Whispering-gallery-mode biosensing: Label-free detection down to single molecules. Nat. Methods 5, 591-596 (2008).
4. Kinkhabwala, A. et al. Large single-molecule fluorescence enhancements produced by a bowtie nanoantenna. Nat. Photonics 3, 654-657 (2009).
5. Aćimović, S. S., Kreuzer, M. P., González, M. U. & Quidant, R. Plasmon near-field coupling in metal dimers as a step toward single-molecule sensing. ACS Nano 3, 1231-1237 (2009).
6. Armani, A. M., Kulkarni, R. P., Fraser, S. E., Flagan, R. C. & Vahala, K. J. Label-free, single-molecule detection with optical microcavities. Science (80-.). 317, 783-787 (2007).
7. Yao, X. et al. Sub-attomole oligonucleotide and p53 cDNA determinations via a high-resolution surface plasmon resonance combined with oligonucleotide-capped gold nanoparticle signal amplification. Anal. Biochem. 354, 220-228 (2006).
8. Goluch, E. D. et al. A bio-barcode assay for on-chip attomolar-sensitivity protein detection. Lab Chip 6, 1293-1299 (2006).
9. Waggoner, P. S., Varshney, M. & Craighead, H. G. Detection of prostate specific antigen with nanomechanical resonators. Lab Chip 9, 3095-3099 (2009).
10. Weizmann, Y., Patolsky, F. & Willner, I. Amplified detection of DNA and analysis of single-base mismatches by the catalyzed deposition of gold on Au-nanoparticles. Analyst 126, 1502-1504 (2001).
11. Zheng, G., Gao, X. P. A. & Lieber, C. M. Frequency domain detection of biomolecules using silicon nanowire biosensors. Nano Lett. 10, 3179-3183 (2010).
12. Sheehan, P. E. & Whitman, L. J. Detection limits for nanoscale biosensors. Nano Lett. 5, 803-807 (2005).
13. Squires, T. M., Messinger, R. J. & Manalis, S. R. Making it stick: Convection, reaction and diffusion in surface-based biosensors. Nat. Biotechnol. 26, 417-426 (2008).
14. Arlett, J. L., Myers, E. B. & Roukes, M. L. Comparative advantages of mechanical biosensors. Nat. Nanotechnol. 6, 203-215 (2011).
15. Jemal, A. et al. Global Cancer Statistics: 2011. CA Cancer J Clin 61, 69-90 (2011).
16. National Cancer Institute. Seer Cancer Statistics Review.
17. Liu, C. et al. Electrokinetic Manipulation Integrated Plasmonic-Photonic Hybrid Raman Nanosensors with Dually Enhanced Sensitivity. ACS Sensors 2, 346-353 (2017).
18. Liu, J., Guo, J., Meng, G. & Fan, D. Superstructural Raman Nanosensors with Integrated Dual Functions for Ultrasensitive Detection and Tunable Release of Molecules. Chem. Mater. 30, 5256-5263 (2018).
19. Xu, X., Kim, K. & Fan, D. Tunable Release of Multiplex Biochemicals by Plasmonically Active Rotary Nanomotors. Angew. Chemie 127, 2555-2559 (2015).
20. Xu, X., Kim, K., Li, H. & Fan, D. L. Ordered arrays of raman nanosensors for ultrasensitive and location predictable biochemical detection. Adv. Mater. 24, 5457-5463 (2012).
21. Xu, X. et al. Near-field enhanced plasmonic-magnetic bifunctional nanotubes for single cell bioanalysis. Adv. Funct. Mater. 23, 4332-4338 (2013).
22. Kim, K., Xu, X., Guo, J. & Fan, D. L. Ultrahigh-speed rotating nanoelectromechanical system devices assembled from nanoscale building blocks. Nat. Commun. 5, 1-9 (2014).
23. Fan, D. et al. Subcellular-resolution delivery of a cytokine through precisely manipulated nanowires. Nat. Nanotechnol. 5, 545-551 (2010).
24. Guo, J., Gallegos, J. J., Tom, A. R. & Fan, D. Electric-Field-Guided Precision Manipulation of Catalytic Nanomotors for Cargo Delivery and Powering Nanoelectromechanical Devices. ACS Nano 12, 1179-1187 (2018).
25. Kim, K., Guo, J., Xu, X. & Fan, D. Micromotors with step-motor characteristics by controlled magnetic interactions among assembled components. ACS Nano 9, 548-554 (2015).
26. Kim, K., Liang, Z., Liu, M. & Fan, D. E. Biobased High-Performance Rotary Micromotors for Individually Reconfigurable Micromachine Arrays and Microfluidic Applications. ACS Appl. Mater. Interfaces 9, 6144-6152 (2017).
27. Kim, K., Zhu, F. Q. & Fan, D. Innovative mechanisms for precision assembly and actuation of arrays of nanowire oscillators. ACS Nano 7, 3476-3483 (2013).
28. Liang, Z. & Fan, D. Visible light-gated reconfigurable rotary actuation of electric nanomotors. Sci. Adv. 4, 1-11 (2018).
29. Liang, Z., Teal, D. & Fan, D. Light programmable micro/nanomotors with optically tunable in-phase electric polarization. Nat. Commun. 10, 1-10 (2019).
30. Huang, Y. et al. Scalable Fabrication of Molybdenum Disulfide Nanostructures and their Assembly. Adv. Mater. 32, 1-9 (2020).
31. Li, W., Li, Z., Bertelsmann, K. & Fan, D. E. Portable Low-Pressure Solar Steaming-Collection Unisystem with Polypyrrole Origamis. Adv. Mater. 31, 1-7 (2019).
32. Li, W., Huang, Y., Liu, Y., Tekell, M. C. & Fan, D. (Emma). Three dimensional nanosuperstructures made of two-dimensional materials by design: Synthesis, properties, and applications. Nano Today 29, 100799 (2019).
33. Li, W. et al. Ultralight and Binder-Free All-Solid-State Flexible Supercapacitors for Powering Wearable Strain Sensors. Adv. Funct. Mater. 27, 1-12 (2017).
34. Guo, J., Chan, A., Li, W. & Fan, D. L. Kirkendall Effect in Creating Three-Dimensional Metal Catalysts for Hierarchically Porous Ultrathin Graphite with Unique Properties. Chem. Mater. 29, 4991-4998 (2017).
35. Li, W., Guo, J. & Fan, D. 3D Graphite-Polymer Flexible Strain Sensors with Ultrasensitivity and Durability for Real-Time Human Vital Sign Monitoring and Musical Instrument Education. Adv. Mater. Technol. 2, 1-9 (2017).
36. Zhu, F. Q. et al. Ultrahigh-density arrays of ferromagnetic nanorings on macroscopic areas. Adv. Mater. 16, 2155-2159 (2004).
37. Xu, X., Wu, M., Asoro, M., Ferreira, P. J. & Fan, D. L. One-step hydrothermal synthesis of comb-like ZnO nanostructures. Cryst. Growth Des. 12, 4829-4833 (2012).
38. University Wafer. Ultra-Thin Silicon Wafers 1 Micron TTV, Low Roughness.
39. Huang, Z., Fang, H. & Zhu, J. Fabrication of silicon nanowire arrays with controlled diameter, length, and density. Adv. Mater. 19, 744-748 (2007).
40. Westcott, S. L., Oldenburg, S. J., Lee, T. R. & Halas, N. J. Formation and adsorption of clusters of gold nanoparticles onto functionalized silica nanoparticle surfaces. Langmuir 14, 5396-5401 (1998).
41. Fleming, M. S. & Walt, D. R. Stability and exchange studies of alkanethiol monolayers on gold-nanoparticle-coated silica microspheres. Langmuir 17, 4836-4843 (2001).
42. Liu, C., Kim, K. & Fan, D. L. Location deterministic biosensing from quantum-dot-nanowire assemblies. Appl. Phys. Lett. 105, (2014).
43. Degtyarev, S. A., Khonina, S. N., Ustinov, A. V. & Kazanskiy, N. L. Lightning-rod effect near sharp dielectric structures. Opt. Technol. Telecommun. 2014 9533, 95330A (2015).
44. Jones, T. B. Electromechanics of particles. (Cambridge university press, 2005).
45. Kemp, G. Capillary electrophoresis: a versatile family of analytical techniques. in Biotechnology and Applied Biochemistry 9-17 (1998).
46. Ajdari, A. Generation of transverse fluid currents and forces by an electric field: Electro-osmosis on charge-modulated and undulated surfaces. Phys. Rev. E—Stat. Physics, Plasmas, Fluids, Relat. Interdiscip. Top. 53, 4996-5005 (1996).
47. Agarwal, S. R., Clancy, C. E. & Harvey, R. D. Mechanisms Restricting Diffusion of Intracellular cAMP. Sci. Rep. 6, 1-11 (2016).
48. Lastwika, K. J. et al. Tumor-derived Autoantibodies Identify Malignant Pulmonary Nodules. Am. J. Respir. Crit. Care Med. 199, 1257-1266 (2019).
49. Xiao, Y. & Isaacs, S. N. Enzyme-linked immunosorbent assay (ELISA) and blocking with bovine serum albumin (BSA)—not all BSAs are alike. J. Immunol. Methods 384, 148-151 (2012).
50. Hermanson, G. T. Bioconjugate Techniques. (academic Press, 2013).

The devices, systems, and methods of the appended claims are not limited in scope by the specific devices, systems, and methods described herein, which are intended as illustrations of a few aspects of the claims and any devices, systems, and methods that are functionally equivalent are intended to fall within the scope of the claims. Various modifications of the devices, systems, and methods in addition to those shown and described herein are intended to fall within the scope of the appended claims. Further, while only certain representative components, materials and method steps disclosed herein are specifically described, other combinations of the components, materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A device comprising:
a substrate having a first surface and a second surface and defining a chamber, the chamber comprising:
a plurality of nanostructures formed from a first semiconductor and protruding from the first surface of the substrate into the chamber;
a target region; and
a first electrode operatively coupled to the substrate.

2. The device of claim 1, wherein the nanostructures comprise nanopillars.

3. The device of claim 1, wherein the first semiconductor comprises silicon.

4. The device of claim 1, wherein the substrate comprises a second semiconductor, such as silicon.

5. The device of claim 1, wherein the substrate further comprises a floor and one or more sidewalls.

6. The device of claim 5, wherein the chamber is a microfluidic channel.

7. The device of claim 1, wherein the first electrode comprises a conductive layer disposed on the first surface of the substrate.

8. The device of claim 1, wherein the first electrode comprises a first conductive layer disposed on the second surface of the substrate.

9. The device of claim 7, wherein the first conductive layer comprises a metallic layer, such as a noble metal layer.

10. (canceled)

11. The device of claim 7, further comprising a polymer layer disposed on the first conductive layer.

12. (canceled)

13. The device of claim 1, further comprising an optically transparent second conductive layer disposed over the chamber.

14. The device of claim 1, further comprising a plurality of recognition elements disposed on the nanostructures.

15. The device of claim 14, wherein the recognition elements comprise a Surface Enhanced Raman Spectroscopy (SERS)-active nanostructured metal.

16. (canceled)

17. The device of claim 15, wherein the SERS-active nanostructured metal comprises a metal selected from the group consisting of Ru, Rh, Pd, Os, Ir, Pt, Au, Ag, Cu, Al, and combinations thereof.

18. (canceled)

19. The device of claim 15, wherein the SERS-active nanostructured metal comprises metal nanoparticles having an average particle size of from 5 nanometers (nm) to 1 micrometer (micron, μm).

20. The device of claim 15, further comprising an antibody, antibody fragment, antibody mimetic, peptide, oligonucleotide, DNA, RNA, aptamer, organic molecule, or any combination thereof associated with the SERS-active nanostructured metal.

21. (canceled)

22. (canceled)

23. The device of claim 14, wherein the recognition elements comprises an antibody, antibody fragment, antibody mimetic, peptide, oligonucleotide, DNA, RNA, aptamer, organic molecule, or any combination thereof associated with the plurality of nanostructures.

24. (canceled)

25. (canceled)

26. The device of claim 1, further comprising a light source operatively positioned to irradiate the target region and a spectrometer operatively positioned to interrogate the target region.

27. (canceled)

28. A method of detecting an analyte of interest in a liquid sample, the method comprising:
contacting the target region of the device of claim 1, with the liquid sample;
irradiating the target region with a light source, thereby increasing the concentration of the analyte of interest in the target region via opto-electrokinetic effect; and
detecting the analyte of interest in the target region.

29. A system comprising:
a light source operably coupled to a device, the device comprising:
a substrate having a first surface and a second surface and defining a chamber, the chamber comprising:
a plurality of nanostructures formed from a first semiconductor and protruding from the first surface of the substrate into the chamber;
a target region; and
a first electrode operatively coupled to the substrate.

30-55. (canceled)
